(19) United States
(12) Patent Application Publication
(10) Pub. No.: US 2010/0134282 A1
(43) Pub. Date: Jun. 3, 2010

(54) Vibe: alarm

(76) Inventor: Sandra Lumley, Moreno Valley, CA (US)

Correspondence Address: RUTH EURE, 4795 EDISON AVENUE, BOULDER, CO, 80301, US

(21) Appl. No.: 12/592,252

(22) Filed: Nov. 20, 2009

Related U.S. Application Data
(60) Provisional application No. 61/200,153, filed on Nov. 25, 2008.

(51) Int. Cl. G08B 21/00

(52) U.S. Cl. 340/540

(57) ABSTRACT

The Vibe: Alarm is an alarm clock equipped with a vibrator that makes it most useful for the deaf and hard of hearing. The Vibe: Alarm is equipped with a vibrator that turns on when the alarm is triggered which makes it most useful for the deaf and hard of hearing. Two switches on the lower part of the housing are used to select pulse or vibrate mode. Each switch is equipped with adjustable settings for low, medium and high intensity. A claw like clamp on the clock housing can be attached to a mattress cord.

### CLAIM OF PRIORITY

This patent application claims priority under 35 USC 119 (e) (1) from U.S. Provisional Patent Application Ser. No. 61/200,153 filed Nov. 25, 2008, of common inventorship herewith entitled, “Vibe: Alarm.”

### FIELD OF THE INVENTION

The present invention pertains to the field of signal devices and alarms, and more specifically to the field of silent alarms.

### BACKGROUND OF THE INVENTION

The prior art has put forth several concepts pertaining to the field of silent alarms. These include:

U.S. Pat. No. 5,764,594 to Berman and Zieg describes a silent alarm clock in the form of a wrist watch having a vibrating alarm.

U.S. Pat. No. 6,151,278 to Najarian describes a remote device for silent awakening which comprises a programmable remote-controlled device for awakening a user through the user's sense of touch.

U.S. Pat. No. 6,975,563 to deBrito describes a test pacing wristwatch with vibration reminder.

None of these references describe the present invention.

### SUMMARY OF THE INVENTION

It is an object of the present invention to provide an alarm clock comprising a digital clock, vibrator for alarm, vibrator having intensity adjusting means, snooze alarm, an optional clip for securing the clock to a mattress. The alarm clock of this invention can be battery powered or powered by a standard electrical cord.

### BRIEF DESCRIPTION OF THE DRAWING

FIG. 1 is a perspective view of the vibrating alarm clock of the present invention.

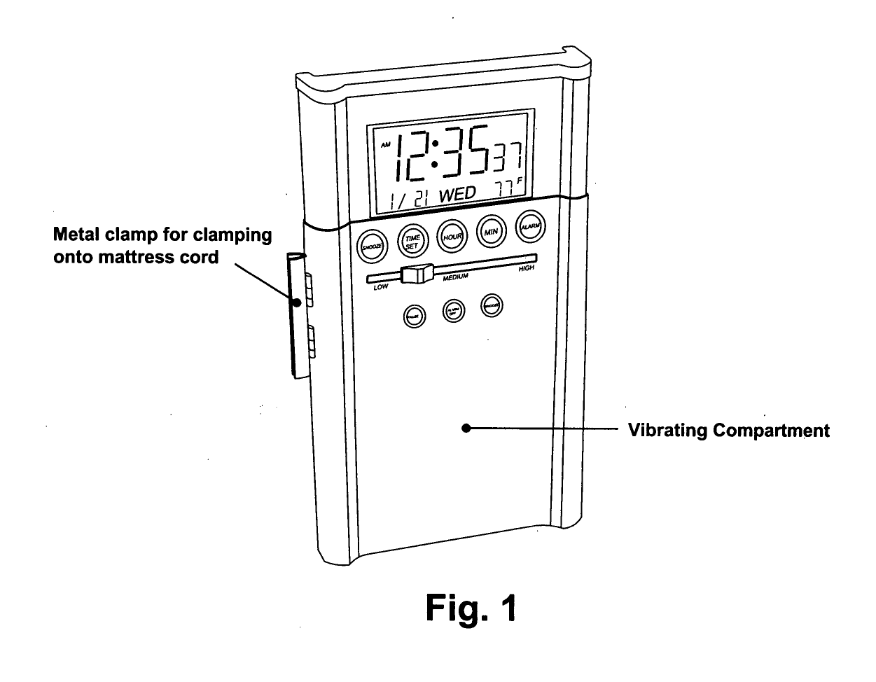

### DETAILED DESCRIPTION OF THE INVENTION

When you see the word deafness you might think of someone who hears nothing at all. But there are different degrees of deafness—profound, severe, moderate and slight. A profound hearing loss is one where all hearing is lost. A hearing aid cannot help a profoundly deaf person.

A severe hearing loss would mean that a hearing aid is a must. With or without the hearing aid, you might use sign language and/or lip-read. A moderate hearing loss would mean that you would have some problems, such as: It's hard to hear when you are talking with others, especially when they're whispering. Talking with others in a crowded room or with background noise is difficult. People with accents are hard to understand. Talking on the phone is sometimes difficult.

Depending on the amount of loss, you might or might not need a hearing aid. If you had slight or mild hearing loss, you wouldn't notice it too much. The millions of individuals that are deaf or hard of hearing are faced with many problems which cannot be envisioned by the majority of the populace who are fortunate enough to have normal hearing. One of the biggest obstacles faced by individuals who are deaf or hard of hearing is the lack of products which are designed for their use. In fairly recent years, closed captioning on television has made it possible for individuals who are deaf or have impaired hearing to fully enjoy watching television. Ringer lights have been invented which make it possible for them to have telephone conversations. Unfortunately, there are many basic, low technology items, items used for the accomplishment of everyday tasks, which are designed only for use by non-handicapped individuals.

One such item is the alarm clock, an essential device which is used by virtually everyone, handicapped and non-handicapped. Having recognized the pressing need for an alarm clock that could meet the special needs of deaf and hearing impaired individuals, the present invention was developed and is hereinafter referred to as the Vibe: Alarm.

The Vibe: Alarm is equipped with an internally contained battery and can operate on DC power as well as AC power. The outer casing is produced from sturdy plastic and is generally rectangular in shape.

The on/off power switches are located on the right side panel and a display dimmer switch is located on the top panel. The upper section of the front panel is occupied by a light emitting diode (LED) display panel which displays the current time or alarm set time. The normal display is current time, alarm time is only displayed when the alarm set select switch is depressed. Adjacent switches, labeled as hour and minute, are used to set the alarm time. The same switches are used when the time set switch has been depressed to set the current time.

An additional switch, the snooze button, is positioned adjacent to the time set switch. A small light emitting diode (LED), positioned to the left of the time display, is illuminated when the time indicated was post meridian (PM) time. A second LED is positioned immediately below and is illuminated when battery power is low. The Vibe: Alarm is equipped with a vibrator that turns on when the alarm is triggered which makes it most useful for the deaf and hard of hearing. Two switches on the lower part of the housing are used to select pulse or vibrate mode. Each switch is equipped with adjustable settings for low, medium and high intensity. A claw like clamp on the clock housing can be attached to a mattress cord to ensure the vibrations are transmitted to the user. The clamp may not operate correctly on all mattresses. The Vibe: Alarm is most beneficial for all people with hearing impairments or would also be useful for the many individuals who hate to be awakened by a blaring alarm clock.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vibrating alarm clock comprising: an internally contained battery; an outer housing produced from sturdy plastic; a generally rectangular shape; a right side panel; a top panel; on/off power switches located on the right side panel; a display dimmer switch located on the top panel; wherein the upper section of the front panel is occupied by a light emitting diode (LED) display panel which displays the current time or alarm set time;
a vibrator which is activated when the alarm is triggered;
a switch on the lower part of the housing is used to select pulse or vibrate mode, wherein each switch is equipped with adjustable settings for low, medium and high intensity;
a claw like clamp on the clock housing can be attached to a mattress cord to ensure the vibrations are transmitted to the user.

2. The vibrating alarm of claim 1 further comprising adjacent switches, labeled as hour and minute and a time set switch.

3. The vibrating alarm of claim 2 further comprising an additional switch, also known as the snooze button, positioned adjacent to the time set switch.

4. The vibrating alarm of claim 2 further comprising a small light emitting diode (LED), positioned to the left of the time display, illuminated when the time indicated was post meridian (PM) time.

5. The vibrating alarm of claim 2 further comprising a second LED positioned immediately below and is illuminated when battery power is low.
